(19) United States
(12) Patent Application Publication
(10) Pub. No.: US 2005/0047076 A1
(43) Pub. Date: Mar. 3, 2005

(54) RETAINING STRUCTURE FOR EXPANSION CARD HOUSINGS

(76) Inventor: Shih-Lung Chien, Jhonghe City (TW)

Correspondence Address: Shih-Lung CHIEN, P.O. Box No. 6-57, Junghe, Taipei, 235, TW

(21) Appl. No.: 10/650,767

(22) Filed: Aug. 29, 2003

(51) Int. Cl. G06F 1/16

(52) U.S. Cl. 361/685

(57) ABSTRACT

A retaining structure for expansion card housings includes a frame and a pair of corresponding upper and lower housings. The frame has step portions provided with tenons for joining and locating the lower housing to be wedged. The frame also has longitudinal grooves and transverse grooves at a front edge thereof to join the upper and lower housings. The lower housing is formed with fastening sections, locating protrusions and locating apertures at wall surfaces of fold portions at two lateral sides thereof. The locating apertures are for fastening to the tenons of the frame. The locating protrusions and fastening sections are for corresponding with fastening apertures and locating recesses at walls surfaces of folded portions of the upper housing. Thus, the upper and lower housings are provided with a multi-directional retaining relationship, and assembly of the expansion card is completed in an expeditious and compact manner.

### BACKGROUND OF THE INVENTION

(a) Field of the Invention

The invention relates to a retaining structure for expansion card housings, and more particularly, to a retaining structure applied for joining upper and lower housings of an expansion card used by computer devices. A multi-directional retaining relationship between the upper housing, the lower housing and a frame is formed and utilized, such that an assembled structure of the upper and lower housings are provided with longitudinal and transverse locating and fastening effects, which are distinct from those of prior retaining structures for housings.

(b) Description of the Prior Art

Assembly means of upper and lower housings of an expansion card are generally accomplished by screwing, inlay and riveting. However, assembly techniques of expansion cards used by related peripherals of portable computers, personal digital assistants (PDA) and electronic dictionaries are rather timing-consuming with high production costs.

From extensive study over prior expansion card structures, it is discovered that, a fastening structure for upper and lower housings of a present expansion card is accomplished in a single direction, or completed by precision of the housings and a frame thereof. However, derived failure rate and insecure fastening are also accompanied with the prior fastening techniques.

### SUMMARY OF THE INVENTION

In the view of the aforesaid shortcomings, the invention provides a retaining structure having simple assembly, so as to overcome difficulties of the prior structure as having unsatisfactory assembly and derived complications. To solve these difficulties, the retaining structure according to the invention is disposed at upper and lower housings of an expansion card, and plasticity of the housings is employed, so that the upper and lower housings are assembled with a frame in a more expeditious manner into a compact structure.

The primary object of the invention is to provide a retaining structure for expansion card housings, in that the retaining structure offers an expeditiously assembled structure accomplished by wedging, thereby elevating compactness of the expansion card.

The retaining structure for expansion card housings according to the invention at least comprises a frame, and a pair of corresponding upper and lower housings. The frame has step portions with drop heights at lateral two sides thereof, wherein the step portions are provided with a plurality of tenons for joining and locating the lower housing to be wedged. The lower housing is formed with fastening sections, locating protrusions and locating apertures at longitudinal wall surfaces of fold portions at two lateral sides thereof. The locating apertures are for fastening to the tenons of the frame. The locating protrusions and fastening sections are for corresponding with fastening apertures and locating recesses at wall surfaces of folded portions of the upper housing. The frame also has longitudinal grooves and transverse grooves at a front edge thereof in order to join the upper and lower housings. Thus, the upper and lower housings are provided with a multi-directional retaining relationship, so as to advance over the single-direction retaining relationship of prior housings while also lowering failure rate.

### BRIEF DESCRIPTION OF THE DRAWINGS

FIG. 1 shows an exploded elevational view according to the invention.

FIG. 2-1 shows a top view of the frame according to the invention.

FIG. 2-2 shows a sectional view of the frame according to the invention.

FIG. 2-3 shows an elevational view of the upper housing according to the invention.

FIG. 2-4 shows an elevational view of the lower housing according to the invention.

FIG. 3-1 shows a sectional view taken along A-A and illustrating an assembled structure of the lower housing and the frame according to the invention.

FIG. 3-2 shows a sectional view taken along B-B and illustrating an assembled structure of the upper and lower housing, and the frame according to the invention.

FIG. 3-3 shows a sectional view taken along C-C and illustrating an assembled structure of the upper and lower housing, and the frame according to the invention.

### DETAILED DESCRIPTION OF THE PREFERRED EMBODIMENTS

To better understand the invention, detailed descriptions shall be given with the accompanying drawings below.

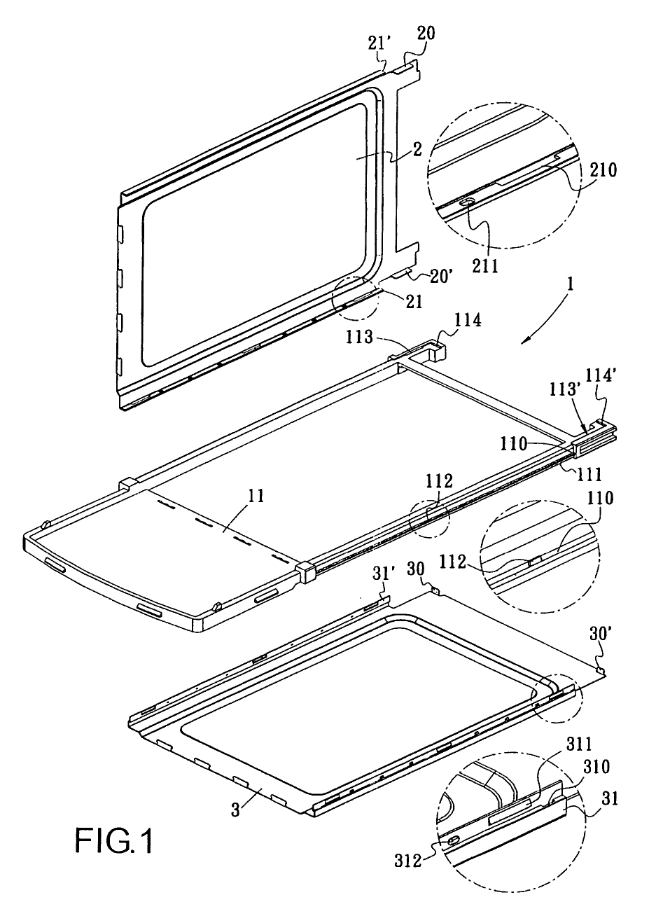

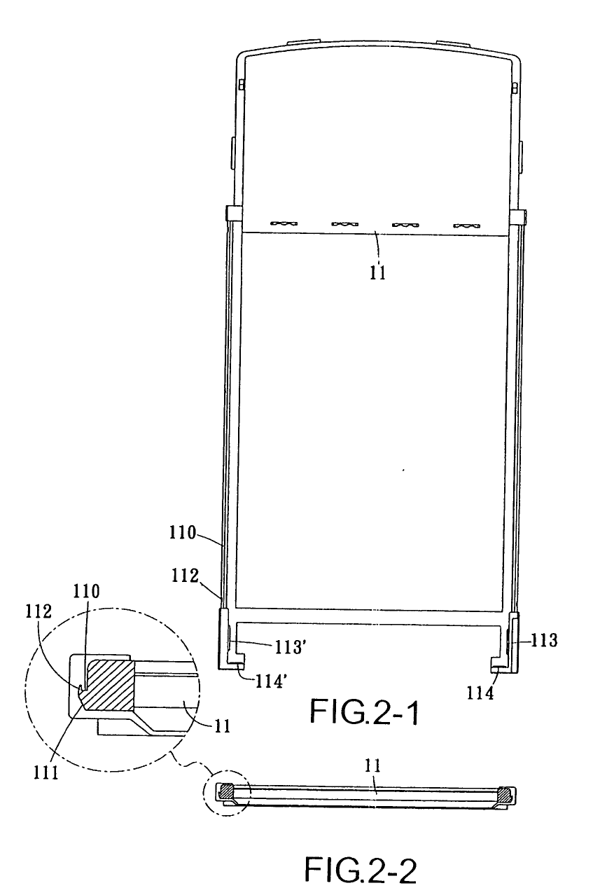

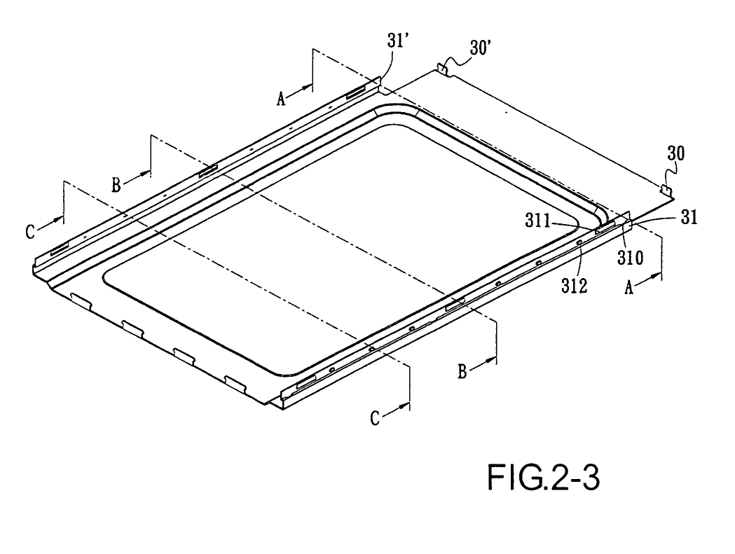

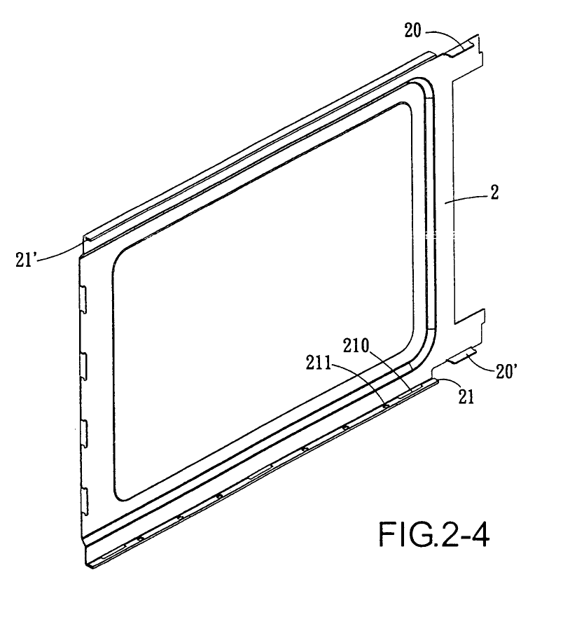

Referring to FIGS. 1 to 2-4, according to the invention, an expansion card 1 at least comprises a frame 11, and a pair of corresponding upper and lower housings 2 and 3. As shown in FIGS. 2-1 and 2-2, the frame 11 is a main support of the entire expansion card 1, and has step portions 110 with certain drop heights at two lateral sides thereof, wherein the step portions 110 are provided with a plurality of tenons 112 for joining and locating locating apertures 310 of the lower housing 3 to be wedged. The frame 11 further has a wedge angle 111 below each of the step portions 110, and the wedge angle 111 is for serving as a guiding angle when wedging the lower housing 3. A front edge of the frame 11 is disposed with corresponding longitudinal grooves 113 and 113′, and transverse grooves 114 and 114′, that are to be fastened to longitudinal fastening pieces 20 and 20′ at a front edge of the upper housing 2, and transverse fastening pieces 30 and 30′ at a front edge of the lower housing 3, so as to develop a multi-directional retaining relationship between the upper and lower housings 2 and 3.

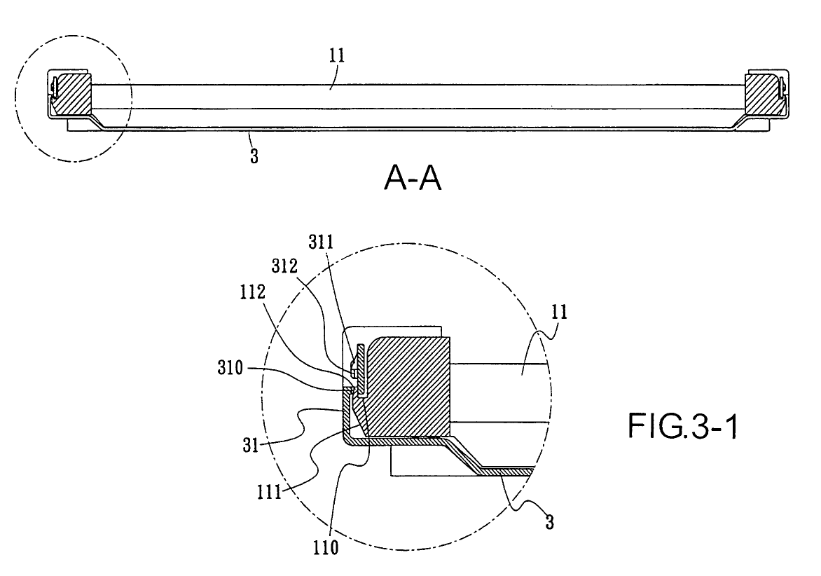

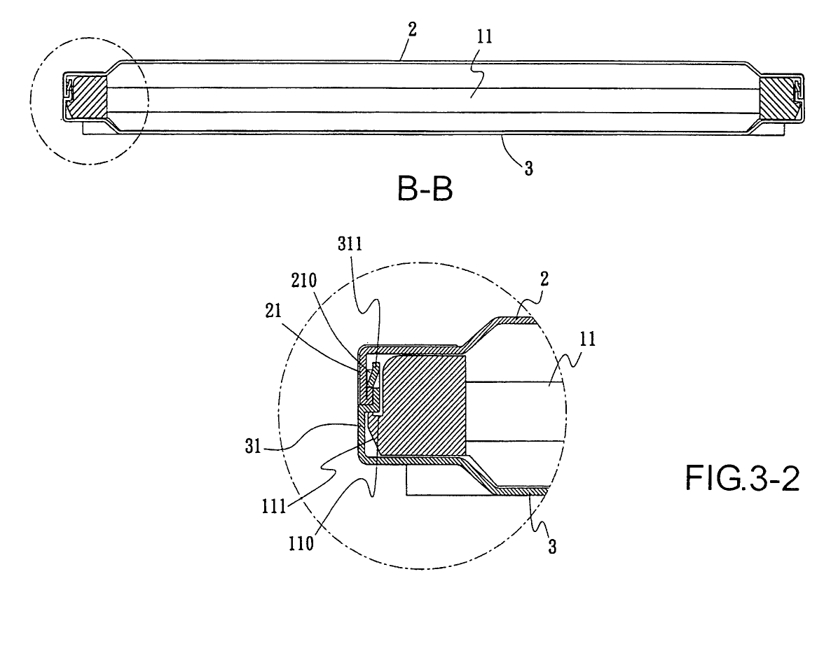

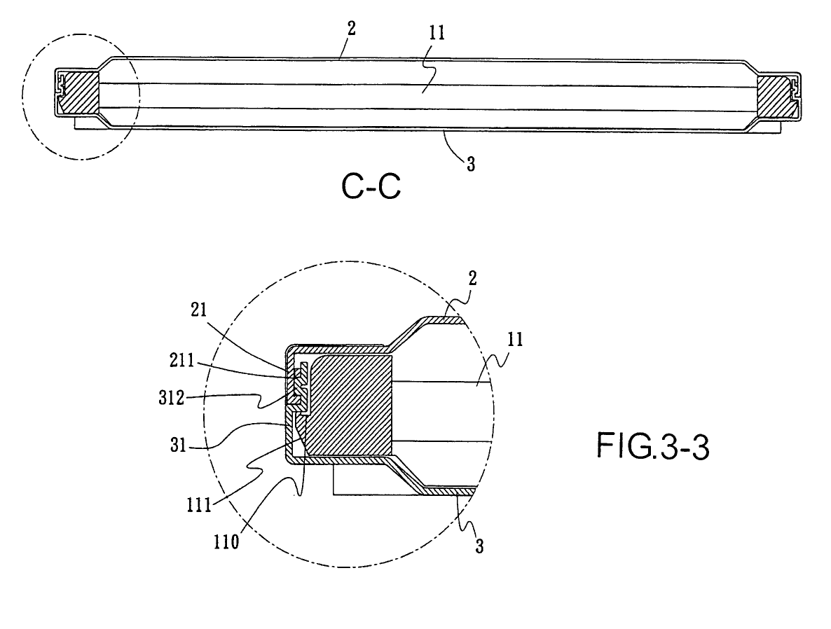

The upper and lower housings 2 and 3 are formed from metal by extrusion and stamping. Referring to FIG. 2-3, the upper housing 2 is formed with folded portions 21 and 21′ at two lateral sides thereof, and the folded portions 21 and 21′ have a plurality of successive fastening elements. Each of the fastening elements is an internal fastening member consisted of a fastening aperture 210 and a locating recess 211. The fastening apertures 210 and the locating recesses 211 are corresponding to fastening sections 311 and locating protrusions 312 serving as fastening elements of the lower housing 3, so as to wedge into and become fastened with each other. In addition, the front side edges of the upper housing 2 are formed with longitudinal fastening pieces 20 and 21, which are embedded into the longitudinal grooves 113 and 113′ of the frame 11 to serve as a fastening mechanism of a front portion of the upper housing 2.

Referring to FIG. 2-4 showing the lower housing 3, the lower housing 3 is formed with folded portions 31 and 31′ at two lateral sides thereof, and the folded portions 31 and 31′ have a plurality of fastening elements corresponding to those of the frame 11. Each of the fastening elements is an internal fastening member consisted of a fastening aperture 310, and an external fastening member consisted of a fastening section 311 and a locating protrusion 312. Furthermore, the locating apertures 310 are for corresponding with the tenons 112 at the step portions 110 of the frame 11, and for serving as a fastening and locating mechanism when joining the lower housing 3 and the frame 1. The fastening sections 311 and the locating protrusions 312 are for corresponding and fastening with the fastening apertures 210 and the locating recesses 211 of the fastening elements of the upper housing 2. In addition, two front sides of the lower housing 3 are provided with transverse fastening pieces 30 and 30′ for joining and wedging into the transverse grooves 114 and 114′ of the frame 11, and serving as a fastening mechanism for a front portion of the lower housing 3.

Referring to FIGS. 3-1, 3-2 and 3-3 showing a sectional view of an assembled structure of the lower housing 3 and the frame 11 taken along A-A, and sectional views of an assembled structure of the upper and lower housings 2 and 3, and the frame 11, respectively, to join the upper and lower housings 2 and 3, and the frame 11, the lower housing 3 and the frame 11 are first wedged to each other, such that the folded portions 31 and 31′ are smoothly glided into and become wedged at the step portions 110 via guidance provided by the wedge angles 111. The locating apertures 310 of the lower housing 3 are aligned with the tenons 112 at the step portions 110, thereby completing joining of the lower housing 3 and the frame 11 as shown by the sectional view taken along A-A.

Next, the upper housing 2 is covered and assembled. At this point, the fastening apertures 210 are fastened with the fastening sections 311 of the lower housing 3 as shown in the sectional view taken along B-B. Also, the locating recesses 211 of the upper housing 2 are corresponded and fastened with the locating protrusions 312 of the lower housing 3 as shown in the sectional view taken along C-C. Hence, the upper and lower housings 2 and 3 are provided with a multiple retaining relationship distinct from that of the retaining structure of the prior housings, so as to assemble the upper and lower housings 2 and 3, and the frame 11 in a more expeditious manner with a compact structure.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A retaining structure for expansion card housings having a retaining structure for upper and lower housings of an expansion card used by computer devices, comprising at least a frame and a pair of corresponding housings; and the characteristics being:
the frame is a main support of the entire expansion card; and has step portions with certain drop heights at two lateral sides thereof, wherein the step portions are provided with a plurality of tenons for joining and locating the lower housing to be wedged, a wedge angle below each of the step portions, wherein each wedge angle serves as a guiding angle when wedging the lower housing, and corresponding longitudinal grooves and transverse grooves at a front edge thereof for joining the upper and lower housings;
the upper cover is joined with the frame and the lower housing; and has folded portions at two lateral sides thereof, wherein the folded portions are provided with fastening elements corresponding to arrangements of fastening elements of the lower housing; and
the lower housing is joined with the frame and the upper housing; and has folded portions with certain drop heights at two lateral sides thereof, wherein the folded portions are provided with locating apertures for corresponding with tenons of the frame, and the wall surfaces of the folded portions further have fastening elements for corresponding with arrangements of the fastening elements of the upper housing.

2. The retaining structure for expansion card housings in accordance with claim 1, wherein the wedge angles of the frame are guiding angles, and are disposed at two corresponding corners of the frame.

3. The retaining structure for expansion card housings in accordance with claim 1, wherein the fastening elements of the upper housing are internal fastening members having fastening apertures and locating recesses.

4. The retaining structure for expansion card housings in accordance with claim 1, wherein the fastening elements of the lower housing are external fastening members having fastening sections and locating protrusions.

5. The retaining structure for expansion card housings in accordance with claim 1, wherein the locating apertures of the lower housings are corresponding with the tenons of the frame, and are wedged into each other for joining and locating the lower housing and the frame.

6. The retaining structure for expansion card housings in accordance with claim 1, wherein the fastening apertures of the upper housing and the fastening sections of the lower housing are correspondingly fastened.

7. The retaining structure for expansion card housings in accordance with claim 3, wherein the fastening apertures of the upper housing and the fastening sections of the lower housing are correspondingly fastened.

8. The retaining structure for expansion card housings in accordance with claim 1, wherein the locating recesses of the upper housing and the locating protrusions of the lower housing are correspondingly fastened.

9. The retaining structure for expansion card housings in accordance with claim 3, wherein the locating recesses of the upper housing and the locating protrusions of the lower housing are correspondingly fastened.
